(19) United States
(12) Patent Application Publication
(10) Pub. No.: US 2019/0342949 A1
(43) Pub. Date: Nov. 7, 2019

(54) HEATER CARTRIDGE WITH CONTROL ELEMENT

(71) Applicant: Türk & Hillinger GmbH, Tuttlingen (DE)

(72) Inventor: Andreas SCHLIPF, Tuttlingen (DE)

(21) Appl. No.: 16/404,953

(22) Filed: May 7, 2019

(30) Foreign Application Priority Data
May 7, 2018 (DE) 20 2018 102 531.7

(51) Int. Cl. H05B 1/02; H05B 3/44; H05B 3/03

(52) U.S. Cl. CPC H05B 1/0236; H05B 3/44; H05B 2203/014; H05B 2203/019; H05B 2203/02; H05B 3/03

(57) ABSTRACT

An electrical heating cartridge with an outer tubular metal casing and a control element arranged inside the outer tubular metal casing. An electrical heating element is arranged at least in sections inside the outer tubular metal casing, wherein the electrical heating element is shaped such that it describes a space curve that defines an interior space. The electrical heating element is electrically insulated from the outer tubular metal casing. The control element is arranged at least in sections embedded in an electrically insulating, heat-conducting material parallel to the direction of extent of the interior space defined by the space curve described by the electrical heating element.

### CROSS-REFERENCE TO RELATED APPLICATIONS

This application claims priority to German Patent Application No. 20 2018 102 531.7, filed on May 7, 2018. The entirety of the aforementioned application is incorporated herein by reference in its entirety.

### BACKGROUND OF THE INVENTION

The invention relates to an electrical heating cartridge with control element.

Electrical heating cartridges with a control element that is suitable for monitoring current operating parameters, especially the temperature load of the heating cartridge, have been known for many years and widely used. They are currently used particularly in applications in the automotive industry.

One notorious problem that occurs with such electrical heating cartridges with control elements is manufacturing them with reliable and consistent processing. One major source of errors in manufacturing involves, on one hand, an exact positioning of the control element and, on the other hand, the fact that the electrical contact between the typically thin connecting wires of such control elements and thicker wires that the thin connecting wires must be connected to fails during the course of the manufacturing process. This leads to an unacceptably high scrap rate in the manufacturing of the electrical heating cartridges.

The problem of the invention therefore consists in disclosing an improved electrical heating cartridge with control element, whose structure preferably allows economical manufacturing with higher degree of reliable and consistent processing. This problem is solved by an electrical heating cartridge with the features of the preferred heating cartridge with control element. Advantageous refinements of the invention are the subject matter of the described preferred invention.

### BRIEF SUMMARY OF THE INVENTION

The electrical heating cartridge according to the preferred invention has an outer tubular metal casing, a control element arranged in the interior of the outer tubular metal casing, and an electrical heating element arranged in the interior of the outer tubular metal casing. Here, the electrical heating element—typically a heating wire—is shaped such that it describes a space curve that defines an interior space. This is the case, for example, for a coiled electrical heating element: here, all the coils are on a cylinder casing and thus define an interior space, namely the interior space of the cylinder bounded on the outside by this cylinder casing. Furthermore, the electrical heating element is electrically insulated from the outer tubular metal casing, preferably with a good heat-conducting material, e.g., magnesium oxide powder or granulate.

It is preferred for the invention that the control element is arranged at least in sections embedded in an electrically insulating, heat-conducting material parallel to the direction of extent of the interior space defined by the space curve described by the electrical heating element.

In a preferred way that the control element is arranged at least in sections embedded in an electrically insulating, heat-conducting material in the interior space defined by the space curve described by the electrical heating element.

Here, it is preferred if the electrical heating element is wound at least in sections on the outer surface of a coil form—for example, a molded part or pressed part made from ceramic—which is arranged in the interior of the outer tubular metal casing, if the electrical heating element is electrically insulated from the outer tubular metal casing at least in the radial direction relative to the coil axis, and if the control element is arranged embedded in an electrically insulating, heat-conducting material in the area surrounded by the outer surface of the coil form.

The whole arrangement is preferably compressed, in order to guarantee good heat transfer.

The control element could be, in particular, a control coil, i.e., a coiled wire section made from a material, whose specific resistance has such a high temperature dependency that, with the given length of the coiled wire section, temperature fluctuations can be detected with the desired accuracy by measuring the resistance of the control coil. The control element, however, could also be a PT sensor, e.g., a PT100 sensor or an NTC element.

It is preferred if the control element is arranged in the interior of a second tubular metal casing that is arranged in the space surrounded by the outer surface of the coil form. In particular, a control element constructed as a control coil can also be arranged as an assembly coiled on a second coil form in the space surrounded by the outer surface of the first coil form. In both cases, this produces a control element that is constructed as an easily manufacturable, pre-assembled, and separately testable and relatively robust assembly, in which forces introduced, for example, in the later production process can be at least partially absorbed by the second tubular metal casing or the second coil form. This is then preferred if the electrical heating element is designed for low-voltage applications, e.g., operation with 24-V operating voltage, as is often the case in the automotive industry, so that high currents occur.

Especially preferred is an improvement of the invention, in which the second tubular metal casing is arranged in a recess or hole of the coil form. In this way, the positioning accuracy, with which the control element can be placed, can be improved even more decisively, which can contribute to better control accuracy. This applies both with respect to the radial positioning accuracy, because the position is specified by the position of the recess, that is, also with respect to the axial positioning accuracy that can be specified, in particular, by the depth of the hole or recess or by a limiting of the insertion depth by a stop.

Here it is preferred if the electrical heating cartridge is closed on its connection-side end with a first closing disk that has openings for feeding through either end sections or connections of the electrical heating element and an opening for feeding through a section of the second tubular metal casing, in which the control element is arranged. Such a construction of the electrical heating cartridge simplifies the finishing, because preassembled electrical heating cartridges can be later finished to form an electrical heating cartridge with a desired type of control by inserting and fixing the control element arranged in the second tubular metal casing.

In particular, in one improvement of this embodiment of the preferred invention, the fixing is achieved in that, in the electrical heating cartridge, there is another closing disk arranged on the connection side next to the first closing disk, which has openings for feeding through either end sections or connections both of the electrical heating element and also of the control element.

The closing disks can each be made from ceramic, PTFE, Teflon, plastic, or a silicone rubber. It is preferred if the two closing disks are made from different materials.

Such a combination of materials can also be achieved by combining a closing disk and a sealing compound.

### BRIEF DESCRIPTION OF THE SEVERAL VIEWS OF THE DRAWINGS

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1 is a partially exploded, side perspective view of a first embodiment of an electrical heating cartridge with control element;

FIG. 2a is a partial cross-sectional view through the electrical heating cartridge with control element from FIG. 1 along the direction of extent of its coil form with control element;

FIG. 2b is a cross-sectional view through a first variant of a control element that can be used in FIG. 2a;

FIG. 2c is a cross-sectional view through a second variant of a control element that can be used in FIG. 2a;

FIG. 2d is a cross-sectional view through a third variant of a control element that can be used in FIG. 2a;

FIG. 3 is a partially exploded, side perspective view of a second embodiment of an electrical heating cartridge with control element;

FIG. 4a is a cross-sectional view through a first variant of a coil form that can be used for the electrical heating cartridges according to a third preferred embodiment of the preferred invention;

FIG. 4b is a magnified, side perspective, cross-sectional view of an end section of the coil form from FIG. 4a;

FIG. 4c is a cross-sectional view through a second variant of a coil form that can be used for electrical heating cartridges according to the preferred invention;

FIG. 4d is a magnified, side perspective, cross-sectional view of an end section of the coil form from FIG. 4c;

FIG. 4e is a cross-sectional view through a third variant of a coil form that can be used for electrical heating cartridges according to the invention;

FIG. 4f is a magnified, side perspective, cross-sectional view of an end section of the coil form from FIG. 4e; and

FIG. 5 is a cross-sectional view through a fourth embodiment of an electrical heating cartridge with control element.

### DETAILED DESCRIPTION OF THE INVENTION

Equivalent components of equivalent embodiments are provided with identical reference symbols with prefixes “1,” “2,” “3,” and “4” to distinguish the first, second, third and fourth preferred embodiments, respectively, as long as nothing else is indicated. However, for increasing the clarity of the figures, not all reference symbols are shown in each figure.

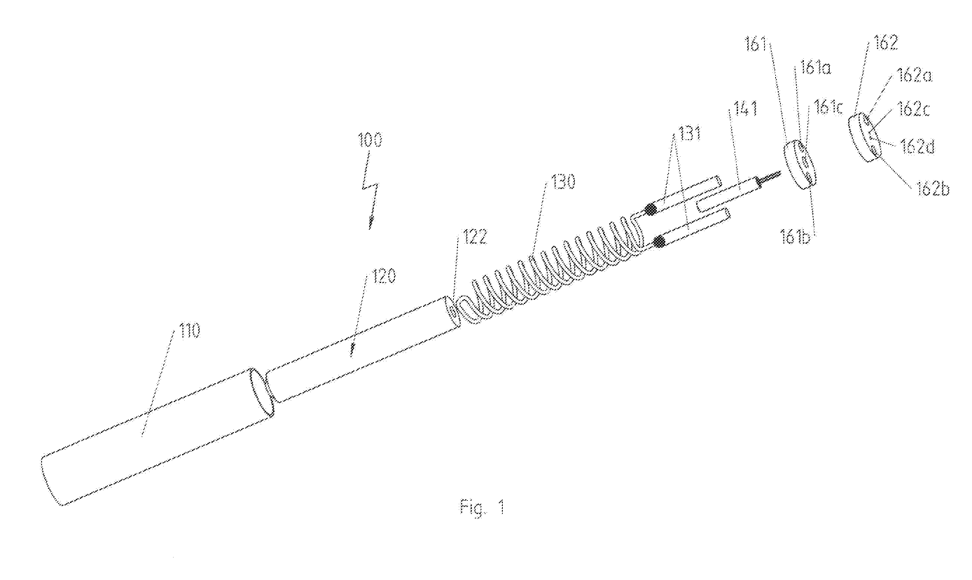

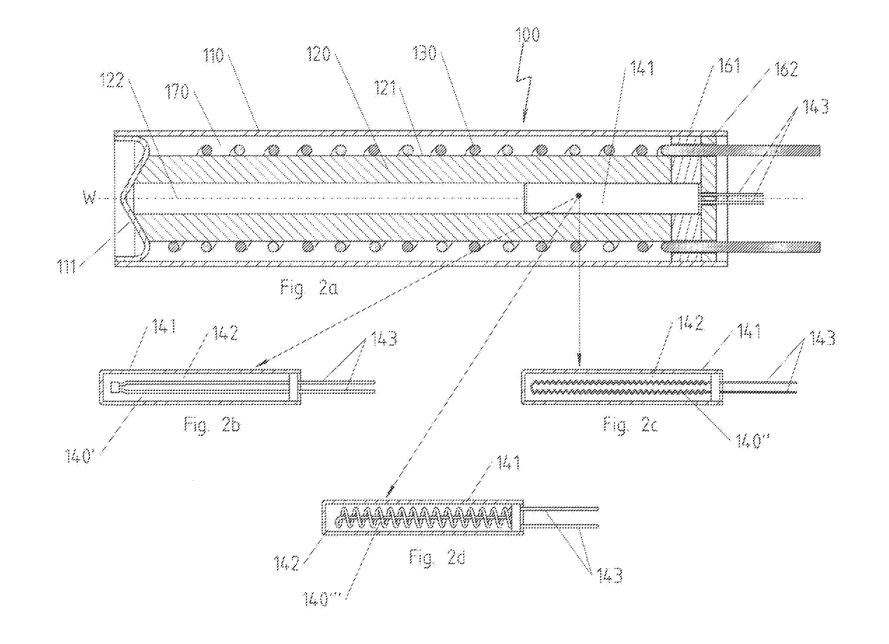

FIGS. 1 and 2a show a first preferred embodiment of an electrical heating cartridge 100 with outer tubular metal casing 110 with base 111, coil form 120 with opening 122, electrical heating element 130 coiled on the outer surface 121 of the coil form 120, and a control element arranged in a second tubular metal casing 141. The electrical heating element 130 is here connected by means of connecting pins 131, which are welded in this example with end sections of the electrical heating element 130. In FIG. 2a, these connecting pins 131 are not shown.

Variants with connections leading out from the electrical heating cartridge from both sides are also possible.

Also visible in FIG. 1 are first and second closing disks 161,162 with openings 161a, 161b, 161c, 162a, 162b, 162c, 162d for the connection-side closing of the electrical heating cartridge 100.

In the case of the first closing disk 161, there are openings 161a, 161b for feeding through end sections of the electrical heating element 130 and the opening 161c for feeding through a section of the second tubular metal casing 141 of the control element. In the case of the second closing disk 162, there are openings 162a, 162b for feeding through end sections of the electrical heating element 130 and openings 162c, 162d for feeding through connecting wires of the control element.

As can be seen particularly well in the section diagram according to FIG. 2a, the coil form 120 is arranged with the bifilar electrical heating element 130 coiled on its outer surface 121 in the inner space or in the interior of the outer tubular metal casing 110 and is supported on the base 111. The remaining volume between the electrical heating element 130 and the inner surface of the outer tubular metal casing 110 is filled with electrically insulating material 170, which has good heat-conducting properties, e.g., MgO powder, so that, in the radial direction relative to the coil axis W, electrical insulation of the electrical heating element 130 from the tubular metal casing 110 is achieved.

The arrows are shown with the intention of connecting the second tubular metal casing 141 in FIG. 2a to FIGS. 2b, 2c, and 2d in such a way that, in the interior of this second tubular metal casing 141, in particular, the control elements 140′ (that is, a PT100 element), 140″ (that is, a self-supporting control coil), or 140′″ (that is, a u-shaped, bent coil) shown in FIGS. 2b, 2c, and 2d can be embedded in electrically insulating material 142, e.g., magnesium oxide, but also other, not-shown control elements.

Here, the control elements 140′, 140″, 140′″ have in common that they are each arranged in the interior of a second tubular metal casing 141 in an electrically insulating material 142, e.g., magnesium oxide, from which, their connections 143 extend on one side.

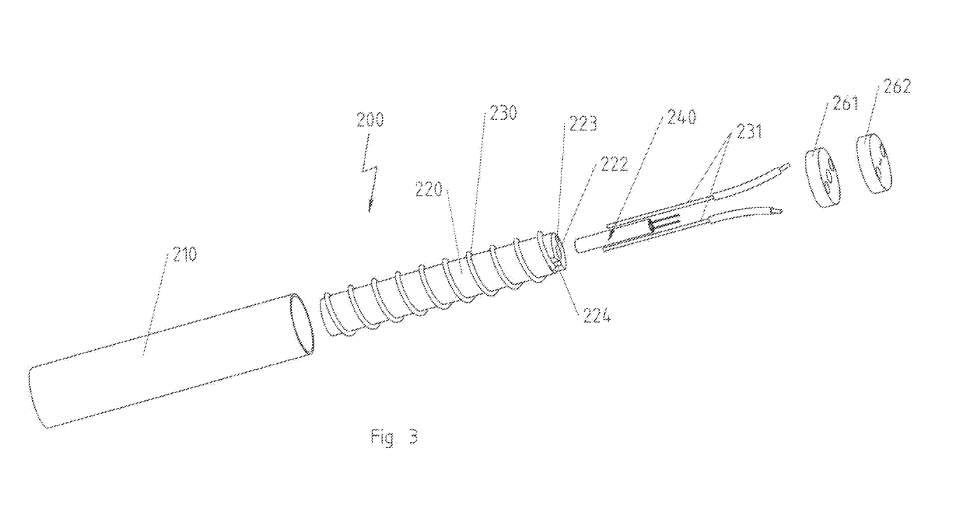

FIG. 3 shows an exploded-view diagram of another or second preferred embodiment of an electrical heating cartridge 200 with outer tubular metal casing 210, coil form 220 with openings 222, 223, 224, electrical heating element 230 coiled on the outer surface 221 of the coil form 220, and a control element arranged in a second tubular metal casing 241. The connection of the electrical heating element 230 is realized in this embodiment by means of a press-fit contacting with connecting wires 231.

As in the case of the first embodiment, a control element that can be constructed as shown, for example, in FIGS. 2b, 2c, and 2d is located in the interior of this second tubular metal casing 241 embedded in electrically insulating material, e.g., magnesium oxide.

Also visible in FIG. 3 are closing disks 261,262 with openings 261a, 261b, 261c, 262a, 262b, 262c, 262d for the connection-side closing of the electrical heating cartridge 200, which are used in the same way as described above in connection with the first embodiment. Not shown, however, is the MgO powder, which here also insures the electrical isolation between electrical heating element 230 and the interior of the outer tubular metal casing.

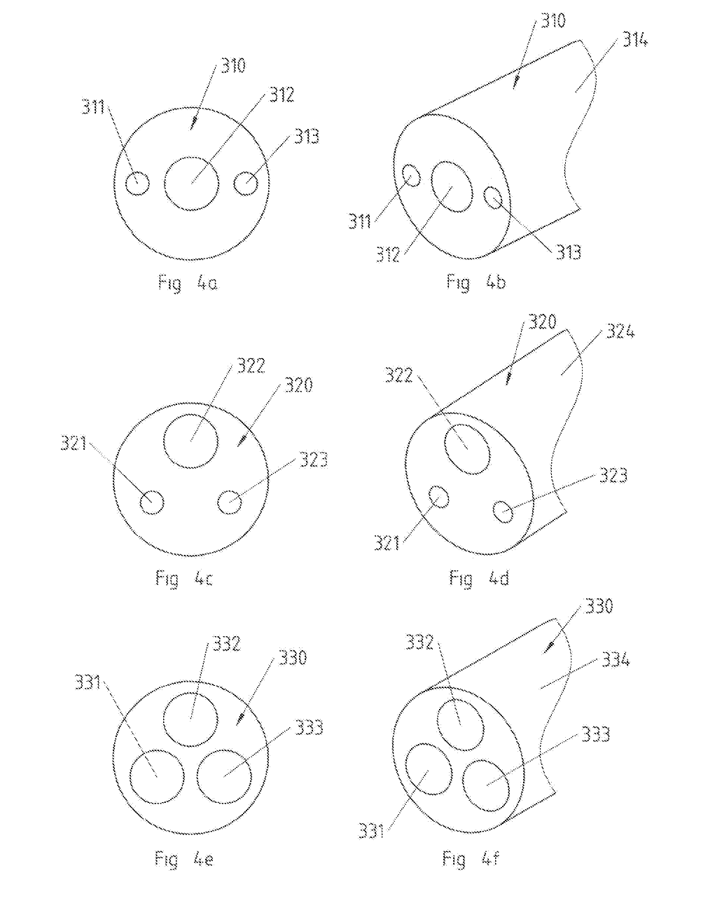

FIGS. 4a to 4f each show, as examples, three variants of third preferred coil forms 310, 320, 330 with openings 311, 312, 313, 321, 322, 323, 331, 332, 333, which can be used for electrical heating cartridges according to the invention, each in a cross-sectional illustration and a view of an end section of the respective coil form 310, 320, 330 with outer surface 314, 324, 334. It can be seen that due to the construction and geometric arrangement of the openings 311, 312, 313, 321, 322, 323, 331, 332, 333, a plurality of variations, especially also with respect to the arrangement of the control element, can be realized.

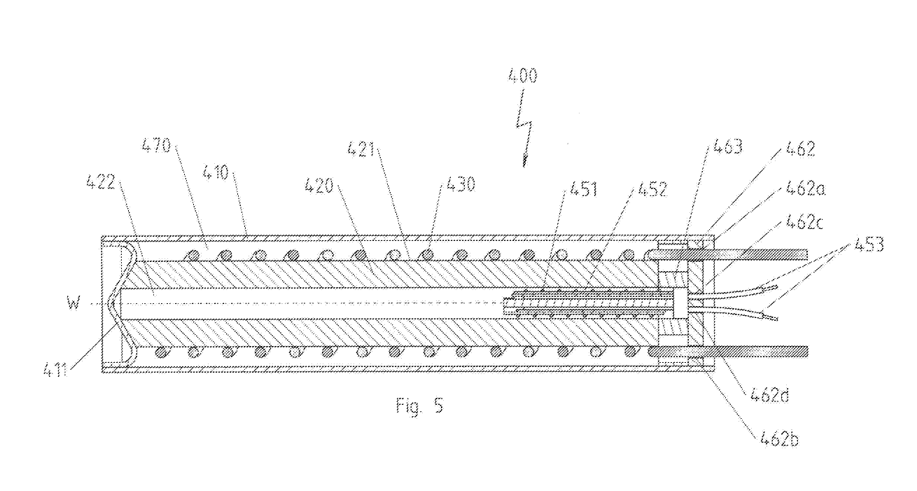

FIG. 5 shows a fourth embodiment of an electrical heating cartridge 400 with outer tubular metal casing 410 with base 411, coil form 420 with opening 422, electrical heating element 430 coiled on the outer surface 421 of the coil form 420, which is electrically insulated from the tubular metal casing 410 by electrically insulating material 470, which has good heat-conducting properties, e.g., MgO powder, in the radial direction relative to the coil axis W.

The electrical heating cartridge 400 of the fourth embodiment differs from the electrical heating cartridge 100 of the first embodiment, as shown, e.g., in FIG. 2a, on one hand, with respect to the control element being used: for the electrical heating cartridge 400 shown in FIG. 5, the control element is formed by a control coil 451, which is coiled on a second coil form 452 and is provided with connecting wires 453. Obviously, this control element is arranged inside the space bounded by the outer surface 421 of the coil form 420 and in the opening 422 of the coil form 420. The embedding in electrically insulating material is guaranteed by the coil form 420 surrounding this control element.

In detail, the electrical contacting of the control coil 451 can be realized in that end sections of the control coil and/or sections of the connecting wires 453 are held in holes that pass through the second coil form 452, and are contacted to each other, in particular, press-fit contacted. Of course, the contacting of the electrical heating element 430 can also be realized in an analogous way, which then leads to an electrical heating device, in which two electrical heating elements are coiled on a coil form and contacted by conductor sections inserted into holes of the coil form.

A second difference consists in that, in the electrical heating cartridge 400 shown in FIG. 5, only one closing disk 462 with openings 462a, 462b, 462c, 462d is used for the connection-side sealing of the electrical heating cartridge 400, which is held by a ring-shaped spacer 463 at a defined distance to the connection-side end side of the coil form 420.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

100,200,400 Electrical heating cartridge
110,210,410 Outer tubular metal casing
111,411 Base
120,220,310,320,330,420 Coil form
121,221,314,324,334,421 Outer surface 122,222,223,224,311,312, 313,321,322,323,331,332,
333,422 Opening
130,230,430 Electrical heating element
131 Connecting pin
140,140′,140″,140′″ Control element
141,241 Second tubular metal casing
142 Electrically insulating material
143 Connection
161,162,261,262,462 Closing disk 161a,161b,161c,162a,162b, 162c,162d,261a,261b,261c, 262a,262b,262c,262d,462a, 462b,462c,462d Opening
170,470 Electrically insulating material
451 Control coil
452 Second coil form
453 Connecting wire
463 Spacer
W Coil axis

1. An electrical heating cartridge comprising: an outer tubular metal casing, with a control element arranged inside the outer tubular metal casing, and with an electrical heating element arranged at least in sections inside the outer tubular metal casing, wherein the electrical heating element is shaped to have a space curve that defines an interior space, and wherein the electrical heating element is electrically insulated from the outer tubular metal casing, wherein the control element is arranged at least in sections embedded in an electrically insulating, heat-conducting material parallel to the direction of extent of the interior space defined by the space curve described by the electrical heating element.

2. The electrical heating cartridge according to claim 1, wherein the control element is arranged at least in sections embedded in the electrically insulating, heat-conducting material inside the interior space defined by the space curve described by the electrical heating element.

3. The electrical heating cartridge according to claim 2, wherein the electrical heating element is coiled at least in sections on an outer surface of a coil form that is arranged in an interior of the outer tubular metal casing, the electrical heating element is electrically insulated from the outer tubular metal casing at least in a radial direction relative to a coil axis, and the control element is arranged embedded in the electrically insulating, heat-conducting material in the space surrounded by the outer surface of the coil form.

4. The electrical heating cartridge according to claim 3, wherein the control element is arranged in the interior of a second tubular metal casing, which is arranged in the space surrounded by the outer surface of the coil form.

5. The electrical heating cartridge according to claim 3, wherein the control element is arranged in an opening, in particular, a recess or hole, of the coil form.

6. The electrical heating cartridge according to claim 4, wherein the electrical heating cartridge is closed on a connection-side end with a first closing disk, which has openings for feeding through either end sections or connections of the electrical heating element and an opening for feeding through a second tubular metal casing, in which the control element is arranged.

7. The electrical heating cartridge according to claim 6, wherein, in the electrical heating cartridge, there is a second closing disk that is arranged on a connection side next to the first closing disk and has openings for feeding through either end sections or connections both of the electrical heating element and also of the control element.

8. The electrical heating cartridge according to claim 7, wherein the first closing disk is made from a different material than the second closing disk.

9. The electrical heating cartridge according to claim 1, wherein the control element is selected from the group consisting of a control coil, a PT sensor, and an NTC element.
